(19) United States
(12) Patent Application Publication
(10) Pub. No.: US 2007/0263116 A1
(43) Pub. Date: Nov. 15, 2007

(54) Solid-state image pickup device and electronic device

(75) Inventor: Motoharu Sakurai, Chiba (JP)

Correspondence Address: OLIFF & BERRIDGE, PLC, P.O. BOX 19928, ALEXANDRIA, VA, 22320, US

(73) Assignee: SEIKO PRECISION INC., NARASHINO-SHI (JP)

(21) Appl. No.: 11/806,826

(22) Filed: Jun. 4, 2007

Related U.S. Application Data
(63) Continuation of application No. PCT/JP05/22490, filed on Dec. 7, 2005.

(30) Foreign Application Priority Data
Dec. 14, 2004 (JP) 2004-361369

(51) Int. Cl. H04N 5/225

(52) U.S. Cl. 348/340

(57) ABSTRACT

A solid-state image pickup device includes a lens-holding member and a substrate. The lens-holding member holds lenses and has a peripheral-wall shape leg located on opposite side of the lens. An image pickup device is mounted on the substrate. The substrate has a device-mounting portion where the image pickup device is mounted, and has a coupling portion that extends from the device-mounting portion and is to be coupled to an external circuit. The device-mounting portion is housed in a space surrounded by the leg. An exterior circumference of the device-mounting portion is fitted into an inner face of the leg. A cutout through which the coupling portion is extracted from the space is formed in the leg.

### BACKGROUND OF THE INVENTION

1. Field of the Invention

This invention generally relates to a solid-state image pickup device and an electronic device, and in particular, relates to a downsized solid-state image pickup device and an electronic device.

2. Description of the Related Art

A solid-state image pickup device is used, being built in an electronic device such as a cellular phone. Generally, the solid-state image pickup device has a structure in which a lens, an optical unit holding the lens, and an image pickup device producing an image through the lens are arranged on a substrate. As a matter of course, it is necessary to determine positions of the lens and the image pickup device included in the optical unit accurately in the solid-state image pickup device.

For example, a solid-state image pickup device in Japanese Patent Application Publication No. 2002-374437 (hereinafter referred to Document 1) discloses a structure, in which two holes are formed in a substrate, an optical unit has projections corresponding to the holes, the projections are fitted into the holes, and a position of a lens in the optical unit and a position of an image pickup device mounted on the substrate are determined in a direction at right angles to an optical axis of the lens.

The holes are formed in the substrate mounting the image pickup device in the positioning structure supposed in Document 1. It is necessary to form the holes outside of a part (an area) mounting the image pickup device. Therefore, size of the substrate is larger than that of the image pickup device by necessity. And the optical unit is upsized according to the substrate, because the optical unit has the projections at positions corresponding to those of the holes. It is therefore difficult to downsize the solid-state image pickup device, when the positioning structure supposed in Document 1 is used.

Recently, an electronic device having a solid-state image pickup device built therein is downsized rapidly. Accordingly, there is a demand for downsizing the solid-state image pickup device to be a built-in component. However, the positioning structure disclosed in Document 1 cannot satisfy the demand.

### SUMMARY OF THE INVENTION

The present invention provides a solid-state image pickup device and an electronic device that determine positions of a lens and an image pickup device accurately and that is downsized.

According to an aspect of the present invention, preferably, there is provided a solid-state image pickup device including a lens-holding member that holds a lens and has a peripheral-wall shape leg located on opposite side of the lens, and a substrate having a device-mounting portion where an image pickup device is mounted, wherein the device-mounting portion is housed in a space surrounded by the leg and is fitted into an inner face of the leg.

According to the present invention, it is possible to determine positions of the lens and the image pickup device in an optical axis direction of the lens accurately, because the device-mounting portion is housed in and fitted into the leg. And the substrate is downsized and the solid-state image pickup device is downsized because a structure for positioning is not necessary.

And it is preferable that the image pickup device is mounted on the device-mounting portion on opposite side of the lens and an end portion of the leg projects beyond the image pickup device toward an opposite side of the lens. And the image pickup device may be adhered to the substrate with a first adhesive agent, and the inner face of the leg may be adhered to the first adhesive agent with a second adhesive agent having a viscosity lower than that of the first adhesive agent.

Further, the lens-holding member may have a lens holder holding the lens and a holder supporting the lens holder, and the leg may be formed in the holder. And the substrate may further have a coupling portion that extends from the device-mounting portion and is to be coupled to an external device, and a cutout through which the coupling portion is extracted from the space may be formed in the leg.

### BRIEF DESCRIPTION OF THE DRAWINGS

Preferred embodiments of the present invention will be described in detail with reference to the following drawings, wherein:

FIG. 1A through FIG. 1C illustrate an exterior view of a solid-state image pickup device; FIG. 1A illustrates a top view of the solid-state image pickup device; FIG. 1B illustrates a side view of the solid-state image pickup device; FIG. 1C illustrates a bottom view of the solid-state image pickup device;

FIG. 2 illustrates a cross sectional view taken along a line A-A in FIG. 1A;

FIG. 3 illustrates a cross sectional view taken along a line B-B in FIG. 1A; and

FIG. 4 illustrates an enlarged view of a circle CR of FIG. 2.

### DESCRIPTION OF THE PREFERRED EMBODIMENTS

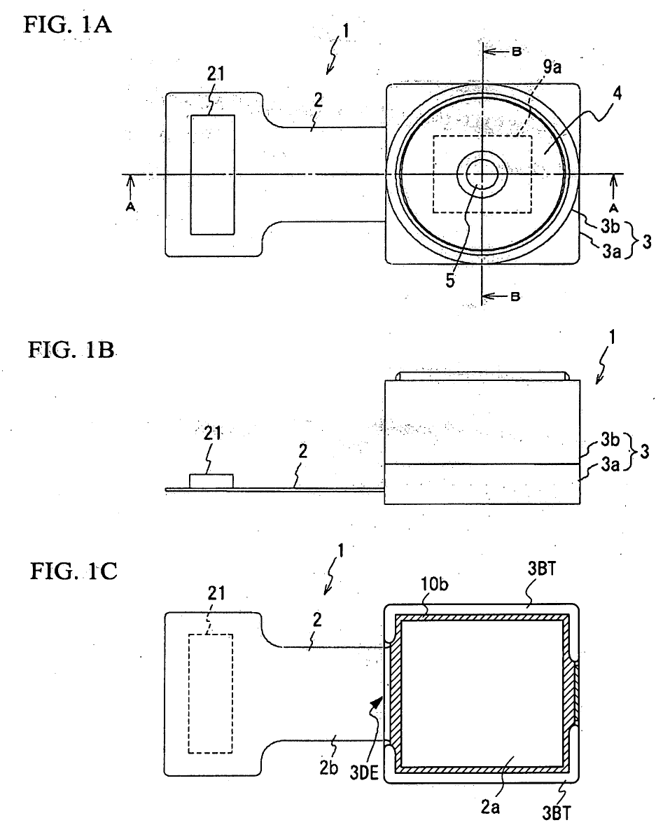

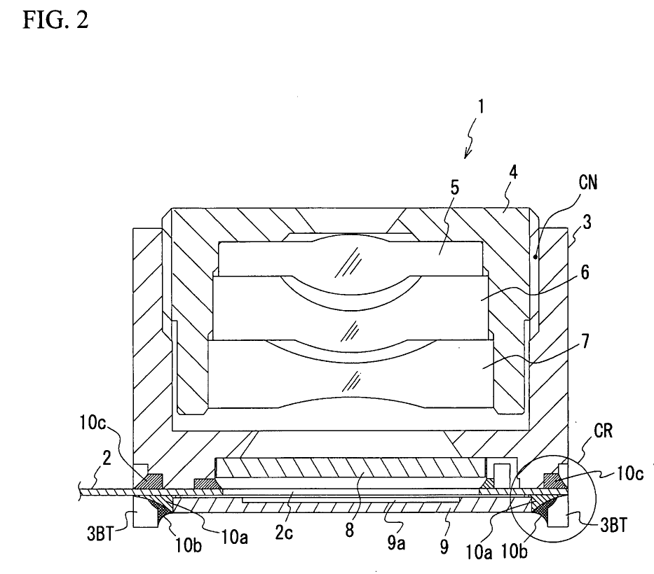

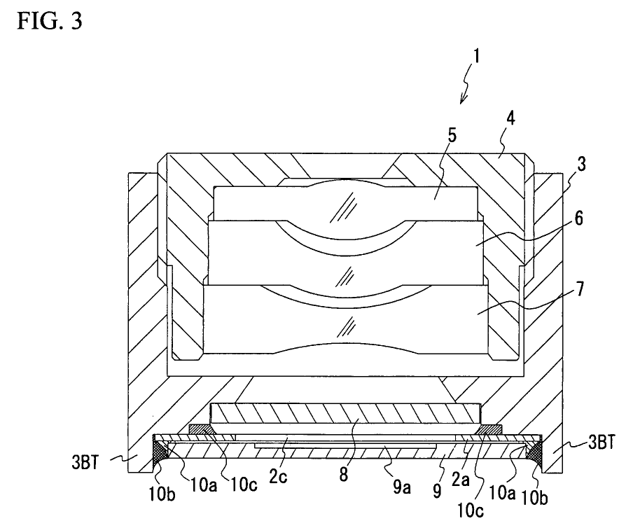

A description will now be given of a solid-state image pickup device in accordance with an embodiment of the present invention, with reference to the accompanying drawings. FIG. 1A through FIG. 1C illustrate an exterior view of a solid-state image pickup device 1. FIG. 1A illustrates a top view of the solid-state image pickup device 1, FIG. 1B illustrates a side view, and FIG. 1C illustrates a bottom view. FIG. 2 illustrates a cross sectional view taken along a line A-A in FIG. 1A. FIG. 3 illustrates a cross sectional view taken along a line B-B in FIG. 1A.

In FIG. 1A through FIG. 1C, the solid-state image pickup device 1 has a lens holder 4 holding a lens 5, an optical unit composed of a holder 3 supporting the lens holder 4, a flexible print substrate 2 (hereinafter referred to a FPC 2 simply) to be electrically coupled to an external device (a circuit). The lens holder 4 has three lenses 5, 6 and 7 therein as shown in FIG. 2. The holder 3 supports the lens holder 4. The holder 3 is composed of a base 3a having a rectangular cylinder shape and of a head 3b formed integrally on the base 3a and having a cylindrical shape. As not shown in the drawings, a thread is formed on an outer circumference of the lens holder 4 and on an inner circumference of the cylindrical head 3b, and the threads screw with each other (with reference to CN in FIG. 2).

The holder 3 holds an optical filter 8 such as an IR filter cutting an infrared light on the under side of the lenses 5, 6 and 7 (on the side opposite to a photogenic subject). Further, the holder 3 holds the FPC 2 mounting an image pickup device 9 on the under side of the optical filter 8.

Here, a description will be given of a relationship between the FPC 2 and the holder 3 in detail. The FPC 2 included in the solid-state image pickup device 1 has a coupling portion 2b and a device-mounting portion 2a, the coupling portion 2b extending outside of the holder 3 in order to be coupled to a circuit of an external device (for example a camera), the device-mounting portion 2a mounting the image pickup device 9. A size (area) of the device-mounting portion 2a of the FPC 2 is reduced to be substantially as same as that of the image pickup device 9. A bottom part of the base 3a of the holder 3 (on the side opposite to the lenses 5 through 7) is a leg 3BT having a peripheral wall shape. A face 3c is in touch with a position of an upper face of the device-mounting portion 2a of the FPC 2 facing the portion to which the image pickup device 9 is coupled, the face 3c being at right angles to the optical axis of the lenses 5 though 7. It is therefore possible to determine the positions of the image pickup device 9 and the lenses 5 through 7 in the optical axis direction of the lenses 5 though 7. The device-mounting portion 2a of the FPC 2 is housed in a space that is under the holder 3 and is surrounded by the leg 3BT. And the coupling portion 2b is extracted outside from the holder 3. A cutout 3DE is formed in the leg 3BT in order to extract the coupling portion 2b. A connector 21 for being coupled to an external device is fixed to an end of the coupling portion 2b. The structure is simplified because the device-mounting portion 2a and the coupling portion 2b are provided on the substrate 2. And it is possible to extract the coupling portion 2b outside of the holder 3 easily, because the cutout 3DE is formed in the holder 3.

The device-mounting portion 2a is formed into a shape corresponding to the size of the holder 3 in the leg 3BT, and the exterior circumference of the device-mounting portion 2a is in touch with the inner circumference of the leg 3BT. Therefore, the device-mounting portion 2a is just fitted into the inner of the leg 3BT, and the positioning is determined. With the above configuration, the holder 3 holds the lenses 5, 6 and 7 at given positions through the lens holder 4, and the device-mounting portion 2a holds the image pickup device 9 at a given position. And the device-mounting portion 2a is fitted into the leg 3BT of the holder 3, and the positioning is determined. Therefore, it is possible to determine the positions of the lenses 5 though 7 and the image pickup device 9 accurately in the direction at right angles to the optical axis in the solid-state image pickup device 1.

In addition, a circuit pattern not shown is formed on the lower face of the device-mounting portion 2a in the solid-state image pickup device 1, as shown in FIG. 2 and FIG. 3. For example, the pattern and the image pickup device 9 are flip-chip coupled to each other. It is thus possible to downsize in a height direction, when the image pickup device 9 is arranged on the under side of the substrate. An opening 2c for imaging is formed in a center area of the device-mounting portion 2a where the image pickup device 9 is mounted, corresponding to an imaging area 9a of the image pickup device 9. It is possible to mount an electronic device on the upper face of the device-mounting portion 2a (a face of the lenses 5 though 7 side).

And the bottom end of the leg 3BT of the holder 3 is formed so as to project from the lower face of the image pickup device 9 toward a direction opposite to the lenses 5 through 7. It is possible to generate a structure in which the image pickup device 9 is included entirely in the space surrounded by the leg 3BT, when the leg 3BT of the holder 3 is long. With the configuration, it is possible to prevent a case where the image pickup device 9 is in touch with other component and is broken, and is possible to protect the image pickup device 9.

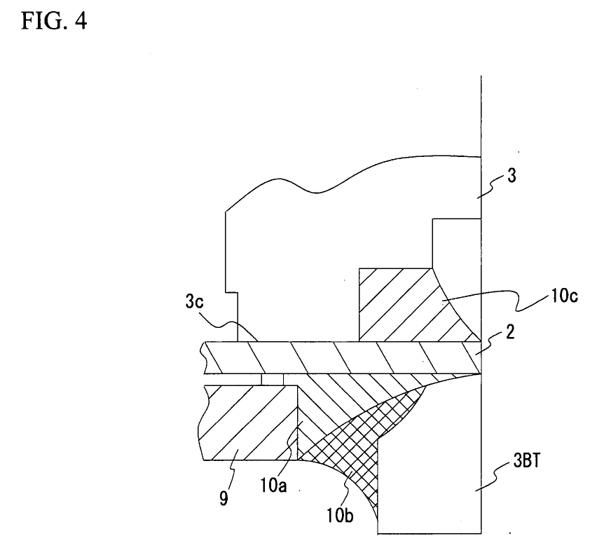

It is possible to fix the device-mounting portion 2a and the image pickup device 9 in the leg 3BT of the holder 3 with an adhesive agent. FIG. 4 illustrates an enlarged view of a circle CR of FIG. 2. Here, a case, where the FPC 2 and the image pickup device 9 are fixed to the inner face of the leg 3BT of the holder 3 with two kinds of adhesive agents, is illustrated. An under fill 10a as a first adhesive agent is coated from around the coupling portion to the side face of the image pickup device 9 mounted on the FPC 2, and the FPC 2 and the image pickup device 9 are coupled to each other. It is preferable that the first adhesive agent is selected from those that have a given viscosity and does not flow into the imaging area 9a of the image pickup device 9 with capillary attraction.

Further, a second adhesive agent 10b is coated from the inner face of the leg 3BT to the side faces of the first adhesive agent 10a and the image pickup device 9 in order to prevent a detachment of the image pickup device 9 reliably. FIG. 1C illustrates the second adhesive agent 10b coated on the inner face of the leg 3BT. The second adhesive agent 10b possibly project downward from the lower end of the leg 3BT of the holder 3 (on the side opposite to the lenses 5 through 7) when the second adhesive agent 10b rises and is solidified, in a case where the second adhesive agent 10b has a high viscosity. When the adhesive agent 10b projects, other component is in touch with the adhesive agent 10b and the image pickup device 9 is subjected to an external pressure through the adhesive agent 10b. Therefore, the effect in a case where the image pickup device 9 is housed in the holder 3 is degraded. And so, it is preferable that an adhesive agent having a relatively low viscosity is used for the second adhesive agent 10b. An adhesive agent having a low viscosity tends to flow to the side of the lenses 5 through 7. Therefore, when there is a clearance between the first adhesive agent and the holder 3, it is possible to fill the clearance with the adhesive agent. It is more preferable that an elastic material, for example a rubber, is used for the second adhesive agent 10b. It is possible to reduce a load to which the image pickup device 9 is subjected from the leg 3BT with the elastic pressure when the rubber is used.

And a third adhesive agent 10c is coated on a touching portion of the face 3c of the holder 3 and the upper face of the device-mounting portion 2a of the FPC 2, and the face 3c and the upper face of the device-mounting portion 2a are adhered to each other. In addition, it is preferable that an adhesive agent having a relatively high viscosity is used for the third adhesive agent 10c in order to prevent the inflow of the third adhesive agent 10c to an effective area of an incoming light necessary for imaging.

The solid-state image pickup device 1 is manufactured through a below process. That is, the first adhesive agent 10a is coated and the image pickup device 9 is fixed after the image pickup device 9 is coupled to the FPC 2 with use of an art of flip-chip mounting. Further, necessary electronic components are mounted. The third adhesive agent 10c is coated on the face 3c of the holder 3, and the face 3c and the upper face of the device-mounting portion 2a are adhered to each other. The lens holder 4 is screwed with the holder 3, the lenses 5 through 7 being adhered to the lens holder 4 in advance. After this, the screw portion is turned and a focus is adjusted. The holder 3 and the lens holder 4 are fixed to each other by coating an adhesive agent (not shown) for fixing on the screw portion. At last, the second adhesive agent 10b is coated from the inner face of the leg 3BT of the holder 3 to the side face of the image pickup device 9, and the solid-state image pickup device 1 is manufactured.

In the solid-state image pickup device 1 mentioned above, the device-mounting portion 2a of the FPC 2 is fitted into the leg 3BT of the holder 3. Therefore, it is possible to align the positions of the FPC 2 and the holder 3 with a simple structure without forming holes in a substrate and providing a projection on the substrate in a conventional way. Therefore, it is possible to take a distinct image, because it is possible to determine the positions of the image pickup device 9 mounted on the FPC 2 and the lenses 5 through 7. And it is possible to promote downsizing of the device because the size of the device-mounting portion 2a of the FPC 2 is reduced to be substantially as same as that of the image pickup device 9. Further, the image pickup device 9 is housed in the space surrounded by the leg 3BT of the holder 3, and it is possible to protect the image pickup device 9 from being in touch with other component and being broken. Further, it is possible to achieve a reliable structure in which a detachment and so on are prevented when the FPC 2 and the image pickup device 9 are adhered in the holder 3 with two kinds of adhesive agents. An electronic device such as a camera, a cellular phone and so on having the solid-state image pickup device 1 built therein can take a small and distinct image.

As mentioned above, a description is given of a case where a flexible FPC is used as an example of a substrate. However, a hard print substrate (PCB:Printed Circuit Board) composed of such as epoxy resin may be used. The solid-state image pickup device 1 has a structure in which a lens-holding member is composed of two members, the holder 3 and the lens holder 4, and a substrate is housed in a leg of the holder 3. However, the lens-holding member may be composed of one member.

And in FIG. 1A through FIG. 1C and FIG. 2, a flow-stopping member preventing the flow of the second adhesive agent 10b outside of the holder 3 may be formed in a cutout formed at the cutout 3DE and at a position facing the cutout 3DE in the leg 3BT. The flow-stopping member can be formed when a resin having a high viscosity is coated on the FPC 2 or the first adhesive agent 10a corresponding to this area.

The preferred embodiments of the present invention have been described. The present invention is not limited to these specific embodiments, but variations and modifications may be made within the scope of the claimed invention.

What is claimed is:

1. A solid-state image pickup device comprising:
a lens-holding member that holds a lens and has a peripheral-wall shape leg located on opposite side of the lens; and
a substrate having a device-mounting portion where an image pickup device is mounted,
wherein the device-mounting portion is housed in a space surrounded by the leg and is fitted into an inner face of the leg.

2. The solid-state image pickup device as claimed in claim 1, wherein:
the image pickup device is mounted on the device-mounting portion on opposite side of the lens; and
an end portion of the leg projects beyond the image pickup device toward an opposite side of the lens.

3. The solid-state image pickup device as claimed in claim 1, wherein:
the image pickup device is adhered to the substrate with a first adhesive agent; and
the inner face of the leg is adhered to the first adhesive agent with a second adhesive agent having a viscosity lower than that of the first adhesive agent.

4. The solid-state image pickup device as claimed in claims 1, wherein:
the lens-holding member has a lens holder holding the lens and a holder supporting the lens holder; and
the leg is formed in the holder.

5. The solid-state image pickup device as claimed in claim 1, wherein:
the substrate further has a coupling portion that extends from the device-mounting portion and is to be coupled to an external device; and
a cutout through which the coupling portion is extracted from the space is formed in the leg.

6. An electronic device comprising a solid-state image pickup device having a lens-holding member and a substrate,
the lens-holding member holding a lens and having a peripheral-wall shape leg located on opposite side of the lens,
the substrate having a device-mounting portion where an image pickup device is mounted,
wherein the device-mounting portion is housed in a space surrounded by the leg and is fitted into an inner face of the leg.

7. The electronic device as claimed in claim 6, wherein:
the image pickup device is mounted on the device-mounting portion on opposite side of the lens; and
an end portion of the leg projects beyond the image pickup device toward an opposite side of the lens.

8. The electronic device as claimed in claim 6, wherein:
the image pickup device is adhered to the substrate with a first adhesive agent; and
the inner face of the leg is adhered to the first adhesive agent with a second adhesive agent having a viscosity lower than that of the first adhesive agent.

9. The electronic device as claimed in claims 6, wherein:
the lens-holding member has a lens holder holding the lens and a holder supporting the lens holder; and
the leg is formed in the holder.

10. The electronic device as claimed in claim 6, wherein:
the substrate further has a coupling portion that extends from the device-mounting portion and is to be coupled to an external device; and
a cutout through which the coupling portion is extracted from the space is formed in the leg.
